(19) United States
(12) Patent Application Publication
(10) Pub. No.: US 2006/0159984 A1
(43) Pub. Date: Jul. 20, 2006

(54) Non-aqueous electolyte battery pack

(76) Inventors: Masatoshi Nagayama, Hirakata-shi (JP); Takuya Nakashima, Osaka-shi (JP); Yoshiyuki Muraoka, Kadoma-shi (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/328,220

(22) Filed: Jan. 10, 2006

(30) Foreign Application Priority Data
Jan. 14, 2005 (JP) 2005-007400
Sep. 30, 2005 (JP) 2005-286448

(51) Int. Cl. H01M 10/42; H01M 2/02

(52) U.S. Cl. 429/61; 429/156; 429/164

(57) ABSTRACT

A non-aqueous electrolyte rechargeable battery pack is provided, which includes a measuring unit for measuring a battery voltage and a battery temperature and a control unit for controlling charge and discharge based on a measuring result of the measuring unit. A plurality of cylindrical non-aqueous electrolyte rechargeable batteries each having positive and negative terminals at a cover and a bottom are accommodated in a battery housing in such a manner that side faces of adjacent non-aqueous electrolyte rechargeable batteries face each other. All the cylindrical non-aqueous electrolyte rechargeable batteries are electrically connected to one another. B/A is set to be in a range between 0.02 and 0.2 where A is a diameter of each cylindrical non-aqueous electrolyte rechargeable battery and B is a distance between the side faces of the adjacent batteries. Due to this, it is possible to realize the non-aqueous electrolyte rechargeable battery pack having a structure suitable for outdoor use as a power source for an electric tool.

The present disclosure relates to subject matter contained in priority Japanese Patent Applications No. 2005-007400 filed on Jan. 14, 2005 and No. 2005-286448 filed on Sep. 30, 2005, the contents of which is herein expressly incorporated by reference in its entirety.

### BACKGROUND OF THE INVENTION

1. Field of the Invention

The present invention relates to a structure of a non-aqueous electrolyte rechargeable battery pack. More particularly, the present invention relates to an arrangement of a plurality of connected batteries for improving the characteristics of the batteries.

2. Description of the Related Art

A non-aqueous electrolyte rechargeable battery such as a lithium ion rechargeable battery has higher energy density than other rechargeable batteries. Thus, applications of the non-aqueous electrolyte rechargeable battery has expanded from consumer applications such as a power source for portable equipment to power-tool applications such as a power source for an electric tool.

Irrespective of a battery system, a rechargeable battery for an electric tool is designed as a cylindrical type that can be easily formed, because an area of an electrode is made larger in order to increase the output characteristics. In an application of a hybrid electric vehicle that was put to practical use ahead of the electric-tool application, an arrangement is usually used in which elongate battery modules, each of which is formed by connecting covers and bottoms of cylindrical batteries, are connected in series while being laid down side by side in a chassis of the vehicle (see Japanese Patent Laid-Open Publication No.2001-155789, for example). A Joule heat generated from each battery during high-rate charge and discharge can be easily accumulated in this arrangement. Thus, a certain size of a gap is provided between the respective modules so as to easily use a cooling air from the outside, in order to enhance a heat dissipation property of a battery pack.

In a non-aqueous electrolyte rechargeable battery for a hybrid electric vehicle, if a large current can be instantaneously obtained at start and acceleration of the vehicle, the vehicle can be driven by an internal-combustion engine after start and acceleration. However, in a non-aqueous electrolyte rechargeable battery for an electric tool, such battery is the only drive source for the tool. In this case, when a structure for enhancing a heat dissipation property of a battery pack is employed, it is difficult to continuously drive the electric tool, for example, if there is a large resistance against a battery reaction under a cold environment.

### SUMMARY OF THE INVENTION

Therefore, it is an object of the present invention to provide a non-aqueous electrolyte rechargeable battery pack having a structure suitable for outdoor use as a power source for an electric tool.

In order to overcome the above problem of the conventional technique, a non-aqueous electrolyte rechargeable battery pack of the present invention comprises: a plurality of cylindrical non-aqueous electrolyte rechargeable batteries each of which has positive and negative terminals respectively provided at a cover and a bottom; a battery housing for accommodating the plurality of non-aqueous electrolyte rechargeable batteries; a measuring unit for measuring a battery voltage and a battery temperature; and a control unit for controlling charge and discharge based on a measuring result of the measuring unit, wherein all of the plurality of cylindrical non-aqueous electrolyte rechargeable batteries are arranged in the battery housing in such a manner that side faces of adjacent ones of the plurality of cylindrical non-aqueous electrolyte rechargeable batteries face each other, and are electrically connected to one another, and B/A is in a range between 0.02 and 0.2 where A is a diameter of each of the cylindrical non-aqueous electrolyte rechargeable batteries and B is a distance between the side faces of the adjacent cylindrical non-aqueous electrolyte rechargeable batteries.

As a result of earnest studies, the inventors of the present invention have found that a structure of a battery pack having an appropriate level of a heat storage property is more suitable for continuous high-rate charge and discharge in a cold environment. More specifically, the distance between the side faces of the adjacent rechargeable batteries is made appropriate while the side faces of the adjacent rechargeable batteries are arranged to face each other. Due to this, an appropriate level of a heat dissipation property is ensured at high temperatures. Moreover, the battery temperature is increased by a Joule heat generated during high-rate charge and discharge in a cold environment, thereby reducing a resistance against a battery reaction and allowing for continuous discharge.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a perspective view of a non-aqueous electrolyte rechargeable battery pack according to an embodiment of the present invention.

FIG. 2 is a cross-sectional view, taken along the line II-II in FIG. 1.

FIG. 3 is a cross-sectional view, taken along the line III-III in FIG. 1.

FIG. 4 is a cross-sectional view, taken along the line IV-IV in FIG. 1.

FIG. 5A to FIG. 5C show exemplary shapes of a notch provided in a separating plate.

### DETAILED DESCRIPTION OF THE PREFERRED EMBODIMENTS

The best mode for carrying out the present invention is described hereinafter, referring to the drawings.

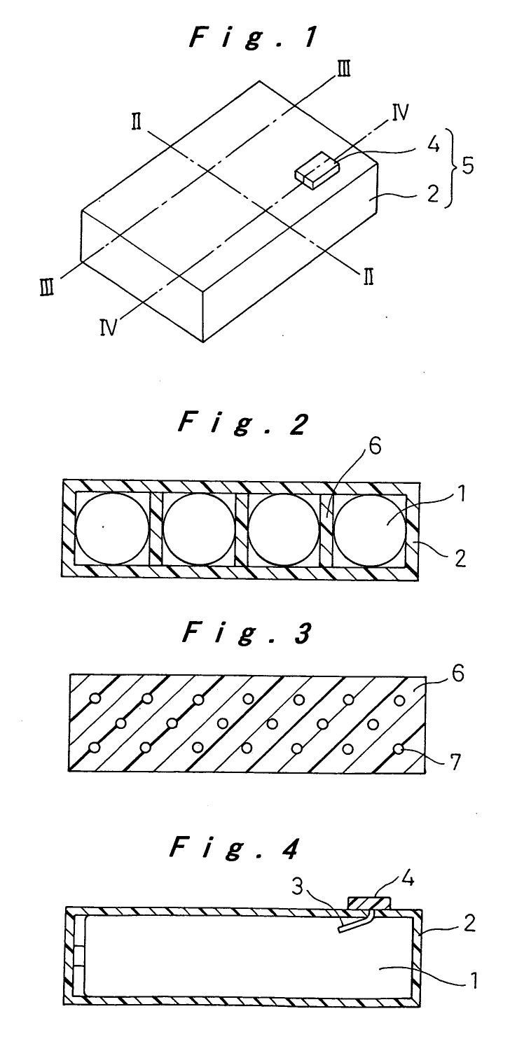

FIG. 1 is a perspective view of a non-aqueous electrolyte rechargeable battery pack according to the present invention. FIGS. 2, 3, and 4 are cross-sectional views of the battery pack shown in FIG. 1, taken along the line II-II, the line III-III, and the line IV-IV, respectively. A plurality of cylindrical non-aqueous electrolyte rechargeable batteries 1 each having positive and negative terminals (not shown) respectively provided at a cover and a bottom are arranged in a battery housing 2 in such a manner that side faces of the adjacent batteries face each other. All the cylindrical non-aqueous electrolyte rechargeable batteries 1 are electrically connected to one other. A measuring unit 3 for measuring a battery voltage and a battery temperature and a control unit 4 for controlling charge and discharge based on a measuring result of the measuring unit 3 are arranged to be adjacent to the cylindrical non-aqueous electrolyte rechargeable battery 1. In this manner, a non-aqueous electrolyte rechargeable battery pack 5 is formed.

All the cylindrical non-aqueous electrolyte rechargeable batteries 1 in the non-aqueous electrolyte rechargeable battery pack 5 have to be arranged in such a manner that the side faces of the adjacent batteries 1 face each other. If the cover of each cylindrical non-aqueous electrolyte rechargeable battery 1 is connected to the bottom of the adjacent cylindrical non-aqueous electrolyte rechargeable battery 1 to form an elongate module as described in Japanese Patent Laid-Open Publication No. 2001-155789 described above, an appropriate level of a heat dissipation property will be achieved at high temperatures. However, in this case, an appropriate level of a heat storage property that is an essence of the present invention will never be achieved because the heat dissipation property is too high in a cold environment.

In order to balance the heat dissipation property and the heat storage property, B/A has to be in a range from 0.02 to 0.2 where A is a diameter of the cylindrical non-aqueous electrolyte rechargeable battery 1 and B is a distance between the side faces of the adjacent rechargeable batteries 1. If B/A is smaller than 0.02, the adjacent batteries are too close to each other. Thus, the heat dissipation property is not good in a high-temperature environment, although a satisfactory level of the heat storage property is obtained. Moreover, if B/A is larger than 0.2, the distance between the adjacent batteries is too large. Thus, the heat storage property is not good in a cold environment, although a satisfactory level of the heat dissipation property is obtained.

It is preferable to provide a separating plate 6 for separating the side faces of the adjacent non-aqueous electrolyte rechargeable batteries 1 from each other in the battery housing 2 in order to set B/A to be in the aforementioned range, from a viewpoint of avoiding a change in the dimension (a value of B/A) caused by oscillation in use. Moreover, it is preferable to provide through holes 7 in the separating plate 6 from a viewpoint of making a generated Joule heat uniform inside the battery pack 5. In addition, it is preferable that an area ratio of the through holes 7 to the separating plate 6 (hereinafter, this ratio is referred to as a vacancy ratio) be in a range from 10 to 70% from a viewpoint of balancing an effect of making the temperature in the battery pack 5 uniform and an effect of ensuring the strength of the separating plate 6. If the vacancy ratio is less than 10%, heat convection caused by the through holes 7 is not sufficient and therefore the uniformity of the temperature in the battery pack 5 is lowered. If the vacancy ratio is larger than 70%, the temperature inside the battery pack 5 easily becomes uniform because of heat convection. However, the strength of the separating plate 6 is lowered and it is therefore difficult to keep the mechanical strength of the battery pack 5. The through holes 7 in the separating plate 6 may be replaced with notches 7 having shapes that are not determined, or a combination of the through holes and the notches may be used. In both cases, the same effects as those described above are obtained.

It is desirable that a voltage of the non-aqueous electrolyte rechargeable batteries 1 of the present invention that are connected in series be in a range from 12.6 to 42V in a full charge state. A non-aqueous electrolyte rechargeable battery usually provides a closed-circuit voltage of about 4.2V in a full charge state, which varies depending on a positive electrode active material. Thus, the most appropriate range described above corresponds to 3 to 10 batteries. If the voltage of the batteries in the full charge state is lower than 12.6V (corresponding to 2 or less batteries), a Joule heat is not sufficient and the heat storage property becomes low. That is, it is difficult to obtain the effects of the present invention. Moreover, if the voltage in the full charge state is higher than 42V (corresponding to 11 or more batteries), excessive heat storage occurs and lowers the heat dissipation property at high temperatures.

According to the present invention, it is desirable that the control unit 4 have a monitoring function of stopping charge and discharge when the measuring unit 3 detects that a surface temperature of the cylindrical non-aqueous electrolyte rechargeable battery 1 is in a range from 60° C. to 80° C. If the temperature at which charge and discharge are stopped is lower than 60° C., charge and discharge are stopped even by very small increase in the battery temperature. If the temperature at which charge and discharge are stopped is higher than 80° C., a timing of stopping electric conduction is delayed when abnormal overheat occurs due to overcharge or the like. This delay causes overheat of the battery pack 5 itself.

Examples of a negative electrode active material contained in a material for a negative electrode of the non-aqueous electrolyte rechargeable battery 1 to which the present invention is applied are carbon materials, crystalline metal oxides and non-crystalline metal oxides that are capable of occluding and releasing lithium. Examples of the carbon materials include non-graphitizing carbon such as coke and glasslike carbon, and graphites that are highly crystalline carbon having an improved crystalline structure. More specifically, examples of the carbon materials are pyrolytic carbon, coke (pitch coke, needle coke, and petroleum coke), graphite, glasslike carbon, a high polymer organic compound calcined material (obtained by firing phenolic resin or furan resin at an appropriate temperature so as to be carbonated), carbon fibers, and activated carbon.

Specific examples of a binder contained in the negative electrode include polyethylene, polypropylene, polytetrafluoroethylene, polyvinylidene fluoride, and styrene-butadiene rubber. A known binder that is usually used in a mixture for the negative electrode of this type of battery may be used. Also, a known additive may be added to the mixture for the negative electrode, if necessary.

Any of conventionally known materials for a positive electrode that is capable of occluding and releasing lithium and includes a sufficient amount of lithium may be used as a positive electrode active material of the non-aqueous electrolyte rechargeable battery 1 to which the present invention is applied. More specifically, it is preferable to use composite metal oxides formed from lithium and transition metal represented by a general formula LiMₓO_{y} (where 1<x≦2, 2<y≦4, and M contains at least one of Co, Ni, Mn, Fe, Al, V, and Ti) or intercalation compounds containing lithium.

A known binder that is usually used in a mixture for the positive electrode of this type of battery may be used as a binder contained in the positive electrode. Specific examples of the binder include polyethylene, polypropylene, polytetrafluoroethylene, polyvinylidene fluoride, and styrene-butadiene rubber. Also, a known additive may be added to the mixture for the positive electrode, if necessary. A specific example of the additive is carbon black.

A non-aqueous electrolyte is one containing an electrolyte dissolved in a non-aqueous solvent.

An example of primary solvent serving as the non-aqueous solvent is ethylene carbonate (hereinafter, referred to as EC) that has a relatively high dielectric constant and is hardly decomposed by graphite forming the negative electrode. In particular, when graphite is used for the negative electrode, it is preferable to use EC as the primary solvent. Alternatively, it is possible to use chemical compounds obtained by substituting halogen for hydrogen atoms in EC.

Moreover, when a part of a material that is reactive with graphite, such as propylene carbonate (hereinafter, referred to as PC) is replaced with secondary solvent, unlike the primary solvent such as EC or the chemical compound obtained by substituting halogen with hydrogen atoms in EC, better characteristics will be realized.

Examples of the secondary solvent include propylene carbonate, butylene carbonate, vinylene carbonate, 1,2-dimethoxyethane, 1,2-diethoxymethane, γ-butyrolactone, valerolactone, tetrahydrofuran, 2-methyltetrahydrofuran, 1,3-dioxolane, 4-methyl-1, 3-dioxolane, sulpholane, and methylsulpholane.

It is preferable to use low-viscosity solvent together with the non-aqueous solvent, thereby improving electric conductivity so as to improve current characteristics and reducing reactivity with lithium metals so as to improve the safety.

Examples of the low-viscosity solvent include symmetric or asymmetric chain carbonic acid esters such as diethyl carbonate, dimethyl carbonate, methylethyl carbonate, and methylpropyl carbonate, carboxylic acid esters such as methyl propionate and ethyl propionate, phosphate esters such as trimethyl phosphate and tryethyl phosphate. Each of those low-viscosity solvents may be used alone, or two or more of the above low-viscosity solvents may be used in combination.

The electrolyte is not specifically limited, as long as it is capable of being dissolved in the non-aqueous solvent and is lithium salt having ion conductivity. Examples of the electrolyte include LiPF₆, LiClO₄, LiAsF₆, LiBF₄, LiB(C₆H₅)₄, LiCH₃SO₃, CF₃SO₃Li, LiCl, and LiBr. In particular, it is preferable to use LiPF₆ as the electrolyte. Each of those electrolytes may be used alone, or two or more of those electrolytes may be used together in combination.

The non-aqueous electrolyte rechargeable battery 1 of the present invention is not limited to the aforementioned lithium ion rechargeable battery. The same effects are also obtained by applying the present invention to battery systems using solid electrolyte and gel electrolyte. Moreover, the diameter and the length of the non-aqueous electrolyte rechargeable battery 1 of the present invention are not limited specifically, as long as the non-aqueous electrolyte rechargeable battery 1 has a cylindrical shape.

Fe, Ni, stainless, Al, and Ti may be used as a material for a battery case. The battery case may be plated in order to prevent electrochemical corrosion by the non-aqueous electrolyte caused by charge and discharge of the battery, for example.

### EXAMPLE 1

(i) Fabrication of Positive Electrode

LiCoO₂ was used as a positive electrode active material in fabrication of the positive electrode. A material for the positive electrode was obtained by mixing lithium carbonate (Li₂CO₃) and cobalt oxide (Co₃O₄) at a predetermined molar ratio and then firing the mixture at a temperature of 900° C. in an air atmosphere for 10 hours.

100 weight parts of the above positive electrode active material, 3 weight parts of acetylene black serving as a conductive agent, and N-methyl pyrrolidone solution of polyvinylidene fluoride adjusted to contain 5 weight parts of polyvinylidene fluoride serving as a binder were mixed while being stirred, thereby a paste-like mixture for the positive electrode was obtained. Then, the paste-like mixture for the positive electrode was applied on both sides of aluminum foil having a thickness of 20 μm, the foil serving as a collector. After the paste-like mixture was dried, the mixture and the aluminum foil were rolled together through rollers. The paste-like mixture and the aluminum foil after rolling were cut to have a predetermined size. In this manner, the positive electrode was fabricated.

(ii) Fabrication of Negative Electrode

The negative electrode was fabricated in the following manner. First, 3 weight parts of styrene-butadiene rubber serving as a binder was mixed with 100 weight parts of scaly graphite that was crashed and classified to have an average grain size of about 20 μm. Then, an aqueous carboxymethylcellulose solution was added in such a manner that solid content of carboxymethylcellulose was 1 weight part. By stirring the mixture, a paste-like mixture for the negative electrode was obtained. The paste-like mixture was then applied on both sides of copper foil having a thickness of 15 μm, the foil serving as a collector, and was dried. After drying, the paste-like mixture and the copper foil were rolled together through rollers and were cut to have a predetermined size. In this manner, the negative electrode was obtained.

(iii) Preparation of Non-aqueous Electrolyte

The non-aqueous electrolyte was prepared by dissolving 1.0 mol/l of LiPF₆ in a solvent that was prepared to contain EC and ethylmethyl carbonate at a ratio of 30:70.

(iv) Fabrication of Non-aqueous Electrolyte Rechargeable Battery

A cylindrical non-aqueous electrolyte rechargeable battery 1 having a diameter of 26 mm and a height of 65 mm was fabricated using the aforementioned positive electrode, negative electrode, and non-aqueous electrolyte. The fabrication procedure is hereinafter described in detail.

The aforementioned positive electrode and negative electrode in the form of strip were stacked with a separator formed by a microporous polyethylene film interposed therebetween, and were then wound a number of times in a longitudinal direction. In this manner, a spiral electrode member was fabricated. The thus fabricated electrode member was accommodated in a battery case formed of iron. The battery case was provided with an insulating plate inserted at its bottom and had an inner surface plated with nickel. Then, one end of a negative lead formed of copper was pressed against the negative electrode so as to be bonded to the negative electrode, and the other end was welded to the battery case. Thus, the battery case became an external terminal of the negative electrode. On the other hand, one end of a positive lead formed of aluminum was attached to the positive electrode and the other end was electrically connected to a cover of the battery via a thin plate for breaking a current in accordance with an internal pressure of the battery. Thus, the cover of the battery became an external terminal of the positive electrode.

The non-aqueous electrolyte prepared by dissolving the electrolyte in the non-aqueous solution was injected into the above battery case. Then, the battery case was caulked and sealed via an insulating sealing gasket with bron applied thereon. Finally, an insulating tube mainly formed of polyethylene terephthalate was shrunk by a heat so as to be integrated with the battery case as one unit. In this manner, the cylindrical non-aqueous electrolyte rechargeable battery 1 was fabricated.

(v) Fabrication of Non-aqueous Electrolyte Rechargeable Battery Pack

4 cells of the non-aqueous electrolyte rechargeable batteries 1 were arranged in a transverse direction and were connected in series. The distance between the adjacent cells was set to 2.6 mm (B/A=0.1). No separating plate was used. The batteries were connected by resistance welding using a connecting board formed of nickel. The measuring unit 3 (thermocouple) for monitoring a temperature was arranged to be in close contact with the insulating tube of the non-aqueous electrolyte rechargeable battery 1 that was arranged at the center of the arrangement of the non-aqueous electrolyte rechargeable batteries 1 in order to measure the temperature of the central battery 1 during charge and discharge. The control unit 4 was set to stop charge and discharge at a temperature of 60° C. (this temperature is called as a monitoring temperature in the following description). Then, the positive and negative terminals of the non-aqueous electrolyte rechargeable batteries 1 were connected to one another. Finally, the thus obtained battery pack was covered with an outer case formed of ABS (acrylonitrile-butadiene-styrene) resin, thereby obtaining the non-aqueous electrolyte rechargeable battery pack shown in FIG. 1. This non-aqueous electrolyte rechargeable battery pack corresponds to Example 1.

### COMPARATIVE EXAMPLE 1

A non-aqueous electrolyte rechargeable battery pack of Comparative Example 1 was fabricated in the same manner as that of Example 1, except that 4 cells of the non-aqueous electrolyte rechargeable batteries 1 were connected in series and were arranged in a longitudinal direction.

### EXAMPLES 2 AND 3 AND COMPARATIVE EXAMPLES 2 AND 3

Non-aqueous electrolyte rechargeable battery packs of Comparative Example 2, Examples 2 and 3, and Comparative Example 3 were fabricated in the same manner as that of Example 1, except that the distances between the adjacent non-aqueous electrolyte rechargeable batteries 1 was set to 0.26 mm (B/A=0.01), 0.52 mm (B/A=0.02), 5.2 mm (B/A=0.2), and7.8 mm (B/A=0.3), respectively.

(vi-a) Shakedown Charge and Discharge

A charge voltage was controlled for each cell in a 25° C. environment in each of the aforementioned non-aqueous electrolyte rechargeable battery packs. Constant-current charge was performed at a charge current of 2 A until the fastest one of the cells reached 4.2V, and thereafter constant-voltage charge was performed until the charge current was reduced to 200 mA. Then, after a 20-minute break, discharge was performed at a current of 25 A until the voltage was reduced to 2.5V.

Evaluation was carried out for each non-aqueous electrolyte rechargeable battery pack after the shakedown charge and discharge in the following manner.

(Low-temperature Discharge Test)

After charge was performed under the same condition as that of the above shakedown charge and discharge, each of the non-aqueous electrolyte rechargeable battery packs was left in a 0° C. environment for 5 hours. Then, each of the non-aqueous electrolyte rechargeable battery packs was discharged to 2.5V at a current of 25 A in the 0° C. environment. The discharging capacity is shown in Table 1.

(High-temperature Charge Test)

Except that the environmental temperature was set to 40° C., charge was performed under the same condition as that of the above shakedown charge and discharge and was stopped when the battery temperature reached the monitoring temperature. The charging capacity is shown in Table 1.

(Oscillation Stability Test)

Each of the non-aqueous electrolyte rechargeable battery packs was oscillated in a 25° C. environment for 30 minutes. The frequency was set to 10 to 30 Hz and the range of oscillation was set to 3 mm. This oscillation process was repeated three times for each of the longitudinal direction and the transverse direction of the non-aqueous electrolyte rechargeable battery pack. Then, the battery pack was disassembled so as to check a change in the distance between the adjacent batteries between before and after the oscillation test. The results are shown in Table 1, in which “large displacement” represents that a change could be observed with eyes, “small displacement” represents that no change was visually observed but a change of 0.1 mm or more was observed in measurement using a slide caliper, and “no displacement” represents that a change amount was less than 0.1 mm.

[Table 1]

From Comparative Example 1, it is shown that the low-temperature discharging capacity is largely reduced by arranging the non-aqueous electrolyte rechargeable batteries 1 in the longitudinal direction. The reason for this is considered that this arrangement has a high heat dissipation property, whereas a heat storage property is not good in a cold environment. Similarly, the low-temperature discharging capacity is also reduced in Comparative Example 3 in which the distance between the non-aqueous electrolyte rechargeable batteries 1 was too large although the batteries 1 were arranged in the transverse direction. However, the reduction amount was smaller than that in Comparative Example 1.

On the other hand, Examples 1 to 3 in which the non-aqueous electrolyte rechargeable batteries 1 were arranged in the transverse direction and the distance between the batteries 1 was appropriately set were excellent in the low-temperature discharging capacity. However, when the distance between the batteries is too small as in Comparative Example 2, the heat storage property tends to be excessively high, making the temperature of the battery reach the monitoring temperature quickly. Thus, the high-temperature charging capacity tends to be lowered. Therefore, in order to achieve the effects of the present invention, it is necessary to arrange the cylindrical non-aqueous electrolyte rechargeable batteries 1 in the transverse direction in the battery housing and set B/A to be in a range from 0.02 to 0.2 where A is the diameter of the cylindrical non-aqueous electrolyte rechargeable battery 1 and B is the distance between the side faces of the adjacent batteries 1. In particular, when B/A is 0.1, both of the low-temperature discharging capacity and the high-temperature charging capacity are high.

### EXAMPLE 4

A non-aqueous electrolyte rechargeable battery pack of Example 4 was fabricated in the same manner as that of Example 1 for which the excellent evaluation results were obtained as described above, except that the separating plate 6 formed of ABS resin was provided in order to keep the distance between the batteries to be 2.6 mm (B/A=0.1).

### EXAMPLES 5 TO 9

Non-aqueous electrolyte rechargeable battery packs of Examples 5 to 9 were fabricated in the same manner as that of Example 4, except that through holes 7 were formed in the separating plate 6 so as to realize the vacancy ratios of 5, 10, 40, 70, and 80%, respectively.

### EXAMPLE 10

A non-aqueous electrolyte rechargeable battery pack of Example 10 was fabricated in the same manner as that of Example 4, except that notches were formed in the separating plate 6 so as to realize the vacancy ratio of 40%.

### EXAMPLES 11 TO 14

Non-aqueous electrolyte rechargeable battery packs of Examples 11 to 14 were fabricated in the same manner as that of Example 7, except that the number of cells was changed to 2, 3, 10, and 12, respectively.

### EXAMPLES 15 TO 18

Non-aqueous electrolyte rechargeable battery packs of Examples 15 to 18 were fabricated in the same manner as that of Example 7, except that the temperature at which charge and discharge were stopped was set to 50, 70, 80, and 85° C., respectively.

(vi-b) Shakedown Charge and Discharge

A charge voltage was controlled for each cell in a 25° C. environment in each of the battery packs of Examples 4 to 18. Constant-current charge was performed at a charge current of 2 A until the fastest one of the cells reached 4.2V, and thereafter constant-voltage charge was performed until the charge current was reduced to 200 mA. Then, after a 20-minute break, discharge was performed at a current of 25 A until the voltage was reduced to 2.5V.

Evaluation was carried out for each of the non-aqueous electrolyte rechargeable battery packs after the shakedown charge and discharge in the following manner.

(Low-temperature Discharge Test)

After charge was performed under the same condition as that of the above shakedown charge and discharge, each non-aqueous electrolyte rechargeable battery pack was left in a 0° C. environment for 5 hours. Then, each non-aqueous electrolyte rechargeable battery pack was discharged to 2.5V at a current of 25 A in the 0° C. environment. The discharging capacity is shown in Table 2.

(High-temperature Charge Test)

Except that the environmental temperature was set to 40° C., charge was performed under the same condition as that of the above shakedown charge and discharge and was stopped when the battery temperature reached the monitoring temperature. The charging capacity is shown in Table 2.

(Oscillation Stability Test)

Each of the non-aqueous electrolyte rechargeable battery packs was oscillated in a 25° C. environment for 30 minutes. The frequency was set to 10 to 30 Hz and the range of oscillation was set to 3 mm. This oscillation process was repeated three times for each of the longitudinal direction and the transverse direction of the non-aqueous electrolyte rechargeable battery pack. Then, each non-aqueous electrolyte rechargeable battery pack was disassembled so as to check a change in the distance between the batteries between before and after the oscillation test. The results are shown in Table 2, in which “large displacement” represents that a change could be observed with eyes, “small displacement” represents that no change was visually observed but a change of 0.1 mm or more was observed in measurement using a slide caliper, and “no displacement” represents that a change amount was less than 0.1 mm.

(Overcharge Stability Test)

A charge test was performed for each of the non-aqueous electrolyte rechargeable battery packs of Examples 5 to 9 and 15 to 18 in a 25° C. environment at a current of 8 A. The charge was stopped at the temperature at which charge and discharge were to be stopped. Note that this temperature was set for each non-aqueous electrolyte rechargeable battery pack. The highest temperature after the charge was stopped, indicated by the measuring unit 3, is shown in Table 2.

[Table 2]

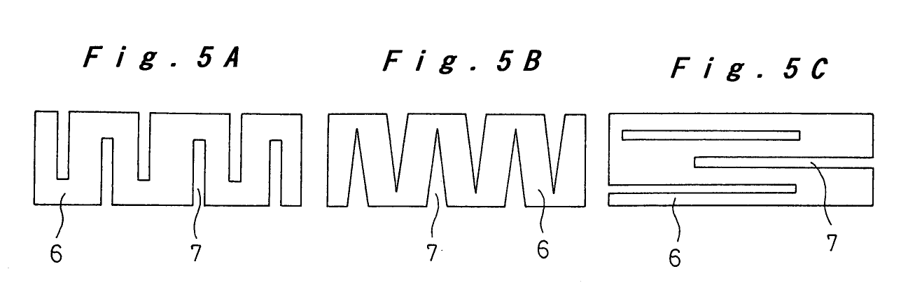

As for an effect of the separating plate 6, resistance to oscillation is higher in Example 4 than in Example 1, although the distance between the batteries is the same in Examples 1 and 4. Thus, if equipment on which the non-aqueous electrolyte rechargeable battery pack of the present invention is mounted has to be resistant to oscillation, it is preferable that the separating plate 6 for separating the side faces of the adjacent batteries be provided in the battery housing 2. Moreover, when the through holes 7 as in Examples 5 to 9 or the notches 7 (see FIG. 5A) as in Example 10 were provided in the separating plate 6, the low-temperature discharging capacity was improved. The reason for this is considered that a Joule heat generated was made uniform inside the battery housing 2 more easily by providing the through holes 7 or the notches 7 in the separating plate 6. However, this effect was not high in Example 5 in which the vacancy ratio was 5%. In addition, the resistance to oscillation was not high in Example 9 in which the vacancy ratio was 80%, because the mechanical strength was lowered. From the above, it is preferable to provide the separating plate 6 between the respective batteries, form the through holes 7 and/or notches 7 in the separating plate 6, and set the vacancy ratio to be in a range from 10 to 70%.

As for the number of cells connected in series, the heat dissipation property was excessively high and the low-temperature discharging capacity was slightly lowered in Example 11 in which the number of the non-aqueous electrolyte rechargeable batteries 1 was 2. On the other hand, the heat storage property was excessively high and the high-temperature charging capacity was slightly lowered in Example 14 in which the number of the non-aqueous electrolyte rechargeable batteries 1 was 12. From the above, it is preferable that the voltage of the non-aqueous electrolyte rechargeable batteries 1 connected in series in a full charge state be in a range from 12.6 to 42V (corresponding to 3 to 10 batteries) in order to obtain the effects of the present invention remarkably.

When a lithium ion battery is charged, the battery temperature is increased by generation of a Joule heat, and abnormal overheat occurs because of structural disorder of the positive electrode active material at temperatures higher than 90° C. Thus, it is necessary to perform the charge within a range in which a normal temperature increase can be ignored, so as not to make the battery temperature higher than the abnormal battery temperature, i.e., 90° C. From this reason, the overcharge stability test was performed for each of the battery packs of Examples 5 to 9 and 15 to 18. In Example 18 in which the monitoring temperature was set to 85° C., the highest temperature reached 97° C. and the overcharge stability was lowered. On the other hand, in Example 15 in which the monitoring temperature was set to 50° C., the highest temperature after the charge was stopped was 52° C. and therefore the overcharge stability was good. However, in Example 15, the charge stopped because of a small temperature increase before the full charge state. Therefore, the high-temperature charging capacity was lowered. From the above, it is preferable that the monitoring temperature in the non-aqueous electrolyte rechargeable battery pack of the present invention be in a range from 60° C. to 80° C.

The above results show that the battery pack that could have the satisfactory mechanical strength, low-temperature discharging property, high-temperature charging property, and overcharge stability was a battery pack in which the separating plate 6 having the vacancy ratio of 10 to 70% was provided, the monitoring temperature was set in a range from 60° C. to 80° C., and the number of batteries was 3 to 10. In particular, better results were obtained for the structure of Example 7.

### EXAMPLES 7A TO 7F

Thus, non-aqueous electrolyte rechargeable batteries of Examples 7A to 7F were fabricated in the same manner as that of Example 7, except that the through holes 7 were formed in the separating plate 6 so as to realize the vacancy ratios of 25, 30, 35, 45, 50, and 55%, respectively.

### EXAMPLES 7G TO 7J

Non-aqueous electrolyte rechargeable batteries of Examples 7G to 7J were fabricated in the same manner as that of Example 7, except that B/A defined by the diameter A of the non-aqueous electrolyte rechargeable battery 1 and the distance B between the adjacent batteries 1 was set to be 0.02, 0.05, 0.15, and 0.2, respectively.

### EXAMPLES 7K AND 7L

Non-aqueous electrolyte rechargeable batteries of Examples 7K and 7L were fabricated in the same manner as that of Example 7, except that the material for the separating plate 6 was changed to UNILATE (a mixture of polyethylene terephthalate, glass fiber, and mica; product name of Kyodo Co., Ltd.) and PPO (polyphenylene oxide), respectively.

(vi-c) Shakedown Charge and Discharge

A charge voltage was controlled for each cell in a 25° C. environment in each of the non-aqueous electrolyte rechargeable battery packs of Examples 7A to 7L. Constant-current charge was performed at a charge current of 2 A until the fastest one of the cells reached 4.2V, and thereafter constant-voltage charge was performed until the charge current was reduced to 200 mA. Then, after a 20-minute break, discharge was performed at a current of 25 A until the voltage was reduced to 2.5V.

Evaluation was carried out for each of the non-aqueous electrolyte rechargeable battery packs after the shakedown charge and discharge in the following manner.

(Low-temperature Discharge Test)

After charge was performed under the same condition as that of the above shakedown charge and discharge, each of the non-aqueous electrolyte rechargeable battery packs was left in a 0° C. environment for 5 hours. Then, each of the non-aqueous electrolyte rechargeable battery packs was discharged to 2.5V at a current of 25 A in the 0° C. environment. The discharging capacity is shown in Table 3.

(High-temperature Charge Test)

Except that the environmental temperature was set to 40° C., charge was performed under the same condition as that of the above shakedown charge and discharge and was stopped when the battery temperature reached the monitoring temperature. The charging capacity is shown in Table 3.

(Oscillation Stability Test)

Each of the non-aqueous electrolyte rechargeable battery packs was oscillated in a 25° C. environment for 30 minutes. The frequency was set to 10 to 30 Hz and the range of oscillation was set to 3 mm. This oscillation process was repeated three times for each of the longitudinal direction and the transverse direction of the non-aqueous electrolyte rechargeable battery pack. Then, the battery pack was disassembled so as to check a change in the distance between the batteries between before and after the oscillation test. The results are shown in Table 3, in which “large displacement” represents that a change could be observed with eyes, “small displacement” represents that no change was visually observed but a change of 0.1 mm or more was observed in measurement using a slide caliper, and “no displacement” represents that a change amount was less than 0.1 mm.

(Overcharge Stability Test)

A charge test was performed for each of the non-aqueous electrolyte rechargeable battery packs of Examples 7A to 7F in a 25° C. environment at a current of 8 A. The charge was stopped at the temperature at which charge and discharge were to be stopped. Note that this temperature was set for each non-aqueous electrolyte rechargeable battery pack. The highest temperature after the charge was stopped, indicated by the measuring unit 3, is shown in Table 3.

[Table 3]

From Examples 7A to 7F, it is shown that the low-temperature discharging capacity and the high-temperature charging capacity were not largely different from those in Example 7 even when the area ratio of the through holes 7 to the separating plate 6 was set to be in a range from 25 to 55%. However, in Example 7F in which the vacancy ratio was set to 55%, the mechanical strength was slightly lowered and therefore the oscillation stability was not as good as that in Examples 7A to 7E. This fact shows that it is more preferable to set the vacancy ratio in a range from 25 to 50%.

In Examples 7G to 7J, the low-temperature discharging capacity and the high-temperature charging capacity were not largely different from those in Example 7, even when B/A was set to be in a range from 0.02 to 0.2 where A was the diameter of the cylindrical non-aqueous electrolyte rechargeable battery 1 and B was the distance between the side faces of the adjacent batteries. However, the low-temperature discharging capacity was slightly lowered in Examples 7H and 7I in which the distance between the batteries was slightly broaden to realize B/A of 0.15 and 0.2, respectively. Moreover, the high-temperature charging capacity was slightly lowered in Examples 7G and 7H in which the distance between the batteries was made slightly narrower to realize B/A of 0.02 and 0.05, respectively. Those facts show that it is more preferable to set B/A to 0.1 where A is the diameter of the cylindrical non-aqueous electrolyte rechargeable battery and B is the distance between the side faces of the adjacent batteries.

Although the battery housing 2 formed of ABS resin and the separating plate 6 formed of ABS resin were used in the aforementioned examples, it is preferable that the material for the separating plate 6 have a higher thermal conductivity than the material for the battery housing 2 in order to make a Joule heat inside the battery housing 2 uniform and prevent escape of an excessive amount of the Joule heat to the outside of the battery housing 2. Since ABS resin has a thermal conductivity of 0.1 to 0.18 W/mK and UNILATE as the material for the separating plate 6 in Example 7K and PPO as the material for the separating plate 6 in Example 7L are 0.25 W/mK or more, the uniformity of the Joule heat in the battery housing 2 is good in Examples 7K and 7L and therefore the low-temperature discharging capacity in Examples 7K and 7L is slightly higher than that in Example 7. From this fact, it is more preferable that the material for the separating plate 6 be UNILATE and PPO.

Moreover, overcharge stability was tested for each of the non-aqueous electrolyte rechargeable battery packs of Examples 7A to 7F. As a result of the test, the highest temperature after the charge was stopped did not exceed 90° C. and the overcharge stability was high in all of the battery packs of Examples 7A to 7F.

Alternatively, the separating plate 6 having a number of circular through holes 7 as shown in FIG. 3 may be replaced with a separating plate 6 that includes notches 7 having various shapes formed therein and has a vacancy ratio that easily makes a Joule heat uniform inside the battery housing 2, as shown in FIGS. 5A to 5C.

As described above, the non-aqueous electrolyte rechargeable battery pack of the present invention has a high volumetric efficiency due to reduction of a cooling path and has a good balance between heat storage and heat dissipation. Thus, the non-aqueous electrolyte rechargeable battery pack of the present invention is useful as a power source for equipment to be used in an outdoor location such as an electric tool, an electric assist bicycle, an electric scooter, or a robot, irrespective of an environment.

Although the present invention has been fully described in connection with the preferred embodiment thereof, it is to be noted that various changes and modifications apparent to those skilled in the art are to be understood as included within the scope of the present invention as defined by the appended claims unless they depart therefrom.

TABLE 1

| | Number | | | | Hole Shape | Monitoring | Low-Temperature | High-Temperature | |
|---|---|---|---|---|---|---|---|---|---|
| | of | | | Separating | and Vacancy | Temperature | Discharging | Charging Capacity | Oscillation |
| | Cells | Arrangement | B/A | Plate | Ratio | (° C.) | Capacity (Ah) | (Ah) | Stability |
| Example 1 | 4 | Transverse | 0.1 | No | No Hole | 60 | 1.88 | 2.43 | Large |
| | | | | | | | | | Displacement |
| Example 2 | 4 | Transverse | 0.02 | No | No Hole | 60 | 1.88 | 2.22 | Large |
| | | | | | | | | | Displacement |
| Example 3 | 4 | Transverse | 0.2 | No | No Hole | 60 | 1.03 | 2.43 | Large |
| | | | | | | | | | Displacement |
| Comparative | 4 | Longitudinal | — | — | — | 60 | 0.55 | 2.50 | Large |
| Example 1 | | | | | | | | | Displacement |
| Comparative | 4 | Transverse | 0.01 | No | No Hole | 60 | 1.88 | 2.05 | Large |
| Example 2 | | | | | | | | | Displacement |
| Comparative | 4 | Transverse | 0.3 | No | No Hole | 60 | 0.87 | 2.45 | Large |
| Example 3 | | | | | | | | | Displacement |

TABLE 2

| | | | | | | | | High- | | |
|---|---|---|---|---|---|---|---|---|---|---|
| | | | | | | | Low- | Temperature | | |
| | Number | | | | Hole Shape | Monitoring | Temperature | Charging | | Highest |
| | of | | | Separating | and Vacancy | Temperature | Discharging | Capacity | Oscillation | Temper- |
| | Cells | Arrangement | B/A | Plate | Ratio | (° C.) | Capacity (Ah) | (Ah) | Stability | ature |
| Example 4 | 4 | Transverse | 0.1 | ABS | No Hole | 60 | 1.85 | 2.45 | No | |
| | | | | | | | | | Displacement | |
| Example 5 | 4 | Transverse | 0.1 | ABS | Hole 5% | 60 | 1.90 | 2.44 | No | 77 |
| | | | | | | | | | Displacement | |
| Example 6 | 4 | Transverse | 0.1 | ABS | Hole 10% | 60 | 2.04 | 2.43 | No | 70 |
| | | | | | | | | | Displacement | |
| Example 7 | 4 | Transverse | 0.1 | ABS | Hole 40% | 60 | 2.05 | 2.40 | No | 62 |
| | | | | | | | | | Displacement | |
| Example 8 | 4 | Transverse | 0.1 | ABS | Hole 70% | 60 | 2.05 | 2.38 | Small | 61 |
| | | | | | | | | | Displacement | |
| Example 9 | 4 | Transverse | 0.1 | ABS | Hole 80% | 60 | 2.04 | 2.39 | Large | 62 |
| | | | | | | | | | Displacement | |
| Example 10 | 4 | Transverse | 0.1 | ABS | Notch 40% | 60 | 2.04 | 2.44 | No | |
| | | | | | | | | | Displacement | |
| Example 11 | 2 | Transverse | 0.1 | ABS | Hole 40% | 60 | 1.07 | 2.52 | No | |
| | | | | | | | | | Displacement | |
| Example 12 | 3 | Transverse | 0.1 | ABS | Hole 40% | 60 | 1.90 | 2.52 | No | |
| | | | | | | | | | Displacement | |
| Example 13 | 10 | Transverse | 0.1 | ABS | Hole 40% | 60 | 2.05 | 2.44 | No | |
| | | | | | | | | | Displacement | |
| Example 14 | 12 | Transverse | 0.1 | ABS | Hole 40% | 60 | 2.04 | 2.22 | No | |
| | | | | | | | | | Displacement | |
| Example 16 | 4 | Transverse | 0.1 | ABS | Hole 40% | 50 | 2.05 | 2.23 | No | 52 |
| | | | | | | | | | Displacement | |
| Example 17 | 4 | Transverse | 0.1 | ABS | Hole 40% | 70 | 2.06 | 2.51 | No | 73 |
| | | | | | | | | | Displacement | |
| Example 18 | 4 | Transverse | 0.1 | ABS | Hole 40% | 80 | 2.04 | 2.52 | No | 85 |
| | | | | | | | | | Displacement | |
| Example 19 | 4 | Transverse | 0.1 | ABS | Hole 40% | 85 | 2.05 | 2.52 | No | 97 |
| | | | | | | | | | Displacement | |

TABLE 3

| | | | | | | | | High- | | |
|---|---|---|---|---|---|---|---|---|---|---|
| | | | | | | | Low- | Temperature | | |
| | Number | | | | Hole Shape | Monitoring | Temperature | Charging | | Highest |
| | of | | | Separating | and Vacancy | Temperature | Discharging | Capacity | Oscillation | Temper- |
| | Cells | Arrangement | B/A | Plate | Ratio | (° C.) | Capacity (Ah) | (Ah) | Stability | ature |
| Example 7A | 4 | Transverse | 0.1 | ABS | Hole 25% | 60 | 2.04 | 2.41 | No | 66 |
| | | | | | | | | | Displacement | |
| Example 7B | 4 | Transverse | 0.1 | ABS | Hole 30% | 60 | 2.04 | 2.40 | No | 63 |
| | | | | | | | | | Displacement | |
| Example 7C | 4 | Transverse | 0.1 | ABS | Hole 35% | 60 | 2.05 | 2.41 | No | 63 |
| | | | | | | | | | Displacement | |
| Example 7D | 4 | Transverse | 0.1 | ABS | Hole 45% | 60 | 2.05 | 2.40 | No | 62 |
| | | | | | | | | | Displacement | |
| Example 7E | 4 | Transverse | 0.1 | ABS | Hole 50% | 60 | 2.05 | 2.40 | No | 61 |
| | | | | | | | | | Displacement | |
| Example 7F | 4 | Transverse | 0.1 | ABS | Hole 55% | 60 | 2.04 | 2.39 | Small | 62 |
| | | | | | | | | | Displacement | |
| Example 7G | 4 | Transverse | 0.02 | ABS | Hole 40% | 60 | 2.07 | 2.32 | No | |
| | | | | | | | | | Displacement | |
| Example 7H | 4 | Transverse | 0.05 | ABS | Hole 40% | 60 | 2.05 | 2.37 | No | |
| | | | | | | | | | Displacement | |
| Example 7I | 4 | Transverse | 0.15 | ABS | Hole 40% | 60 | 2.03 | 2.41 | No | |
| | | | | | | | | | Displacement | |
| Example 7J | 4 | Transverse | 0.2 | ABS | Hole 40% | 60 | 1.97 | 2.42 | No | |
| | | | | | | | | | Displacement | |
| Example 7K | 4 | Transverse | 0.1 | UNILATE | Hole 40% | 60 | 2.08 | 2.40 | No | |
| | | | | | | | | | Displacement | |
| Example 7L | 4 | Transverse | 0.1 | PPO | Hole 40% | 60 | 2.07 | 2.39 | No | |
| | | | | | | | | | Displacement | |

What is claimed is:

1. A non-aqueous electrolyte rechargeable battery pack comprising:
a plurality of cylindrical non-aqueous electrolyte rechargeable batteries each of which has positive and negative terminals respectively provided at a cover and a bottom;
a battery housing for accommodating the plurality of non-aqueous electrolyte rechargeable batteries;
a measuring unit for measuring a battery voltage and a battery temperature; and
a control unit for controlling charge and discharge based on a measuring result of the measuring unit, wherein
all of the plurality of cylindrical non-aqueous electrolyte rechargeable batteries are arranged in the battery housing in such a manner that side faces of adjacent ones of the plurality of cylindrical non-aqueous electrolyte rechargeable batteries face each other, and are electrically connected to one another, and
B/A is in a range between 0.02 and 0.2 where A is a diameter of each of the cylindrical non-aqueous electrolyte rechargeable batteries and B is a distance between the side faces of the adjacent cylindrical non-aqueous electrolyte rechargeable batteries.

2. The non-aqueous electrolyte rechargeable battery pack according to claim 1, wherein the battery housing includes a separating plate for separating the side faces of the adjacent non-aqueous electrolyte rechargeable batteries.

3. The non-aqueous electrolyte rechargeable battery pack according to claim 2, wherein the separating plate has any one of a through hole, a notch, and a combination of the through hole and the notch.

4. The non-aqueous electrolyte rechargeable battery pack according to claim 3, wherein an area ratio of an of the through hole, the notch, and the combination of the through hole and the notch to the separating plate is in a range between 10 and 70%.

5. The non-aqueous electrolyte rechargeable battery pack according to claim 1, wherein a voltage of the non-aqueous electrolyte rechargeable batteries connected in series in a full charge state is in a range between 12.6 and 42V.

6. The non-aqueous electrolyte rechargeable battery pack according to claim 1, wherein the control unit has a monitoring function of stopping charge and discharge when the measuring unit on a surface of at least one of the non-aqueous electrolyte rechargeable batteries reaches a predetermined temperature, the predetermined temperature being in a range between 60° C. and 80° C.
